(19) United States
(12) Patent Application Publication
(10) Pub. No.: US 2017/0242979 A1
(43) Pub. Date: Aug. 24, 2017

(54) METHOD OF PERFORMING CLINICAL TRIALS

(71) Applicant: Brody Holohan, San Francisco, CA (US)

(72) Inventor: Brody Holohan, San Francisco, CA (US)

(21) Appl. No.: 15/441,200

(22) Filed: Feb. 23, 2017

Related U.S. Application Data
(60) Provisional application No. 62/298,885, filed on Feb. 23, 2016.

(51) Int. Cl. G06F 19/00; G06F 19/18; H04L 29/06

(52) U.S. Cl. CPC G06F 19/363; H04L 63/08; G06F 19/18

(57) ABSTRACT

An online clinical trial enrollment system enables patients to directly input their data for standardized processing. It has the steps of a. a patient-operated device for reading displayed commands and inputting responses; b. a server programmed to archive and process data from a plurality of patients, compare, analyze and aggregate information, perform statistical analysis and produce reports on a viewing screen and paper; c. a new user registration; d. an informed consent with pages of information on the clinical trial and pages for user consent; e. a qualifying questionnaire; f. a genotype upload and transfer with a screen; g. display of optimal clinical trial choice with user compliance question; and h. screens with specific information and more detailed questionnaire.

### CROSS REFERENCE TO RELATED APPLICATION

This application claims priority from U.S. Provisional Patent Application Ser. No. 62/298,885 filed Feb. 23, 2016 which is incorporated by reference in its entirety in this application.

### TECHNICAL FIELD

This invention relates to streamlined, online methods of performing clinical trials, more specifically enabling patients to directly input data without clinic visits.

### BACKGROUND

Our relationship with food is highly problematic. While foods of various types are widely available, commercial forms often contain additional ingredients that have been identified as increasing food desirability and attendant overeating, as increasing food shelf life and attendant high sodium. Different foods and liquids and the advertising and promotion thereof can even contribute to addiction. At the same time, people are becoming more aware of their individual differences in processing food, for example, gluten that needs to be avoided by some but for others serves as a source of protein.

Recently tests for food “allergies” have become commercially available. Reaction of blood antibodies and/or immune cells with various food substances is one route to discovering a problem with one's individual ability to process food. Evidence of an allergy may not show up if the individual has not been recently exposed to the allergen.

Genetic polymorphisms that impact biological function of the genome and the products of the genome affect the way that individuals respond to their environments. This phenomenon is well documented in a number of cases, such as in the case of individuals with polymorphisms in the genes required for the proper metabolism of ethanol that are far more sensitive to the negative effects of ethanol consumption. Interactions between these genetic polymorphisms, the relevant environmental factor (such as ethanol) and the output of some biological process are known as Gene-Environment interactions (GxEs). It is probable that a huge number of GxEs exist that are as yet undiscovered, and a large number of the documented GxEs have only been observed in a single study, and have never been validated through an interventional trial. The observation of a GxE does not confer certainty that modification of the environmental factor will necessarily produce a change in the response factor, because GxEs can arise from a number of non-causal relationships.

GxEs could arise from 1) a causal relationship (for example, if people with a given genotype are obese because they drink caffeine), 2) a reverse causal relationship (for example, if people with a given genotype are drinking caffeine because they are obese), 3) a third factor causes the two observations (for example, if people with a given genotype are predisposed to addictive behaviors they may be obese and drink caffeine because of this addictive predisposition), or 4) statistical artifacts as a result of imperfect multiple testing cutoffs. In order to evaluate which of these GxEs are causal, and therefore can be used to provide genetically tailored lifestyle modifications that will improve the health of an individual, interventional testing of these GxEs is required.

### BRIEF DESCRIPTION OF THE DRAWINGS

FIG. 1 is an overview of the new system.

FIGS. 2A and 2B shows listed variables for selection (FIG. 2A) and a separate screen for changing or creating a new variable (FIG. 2B).

FIGS. 3A and 3B relate to the study description with selections for explanations and processing (FIG. 3A) and a selection of possible test substances, as well as questions for the patient (FIG. 3B).

FIGS. 4A and 4B allow selection of test substances by checking a box (FIG. 4A) and addition of a new substance (FIG. 4B).

FIGS. 5A and 5B show how the API allows the addition of questions through the question overview page (FIG. 5A) and the screen on which to add or modify questions (FIG. 5B).

FIGS. 6A-6D show simulations of an increase of decrease of BMI v caffeine intake intervention. Hypothetical subjects were generated with genotypes at 400 simulated GxEs, initial caffeine intake sampled from a distribution shown in FIG. 6A and compliance with the proposed intervention sampled from a distribution shown in FIG. 6B. A histogram of response to the interve3ntion for all simulated subjects is shown in FIG. 6C, and change in BMI is shown compared to change in caffeine intake in FIG. 6D.

FIGS. 7A-7C demonstrate the analysis method and back-casting. Each GxE, rank-ordered by total number of correct predictions is shown in FIG. 7A, with causal loci in red and non-causal loci in blue, while the total number of correct predictions is shown for each group of GxEs in FIG. 7B. Back-casting of the GxEs revealed a maximal percentage of correct predictions when the top-performing 18% of loci were included in a prediction, with >90% of the subjects' responses being correctly predicted in FIG. 7C.

### DETAILED DESCRIPTION

The inventive method facilitates tests for health problems that are not well addressed by modern medicine. It enables us to find new and inexpensive non-prescription treatments to help patients. We make the clinical trial process faster, cheaper, larger and more accessible to the people who want these trials the most, all with the highest standards of scientific quality control and ethical oversight. We use the clinical testing to build an “owner's manual” personalized to each individual's genetics. We drive down the cost of clinical testing of foods, medical devices and nutritional supplements so much that we intend to make our methodology the standard procedure for companies launching a new product. This system is designed to improve treatment and prevention of the most widespread health problems in the developed world.

The scientific community has only begun to collect GxE data. However, that was enough for us to discern possible correlations that require analysis and verification through clinical trials. In the past, the cost of such verification has been prohibitive and has prevented large-scale testing of the interactions between the genome and the environment; even a minimal test of a food-based product in a traditional clinical trial typically costs in excess of $100,000, with considerably larger costs for larger tests. Our key innovation is a transformative method to perform safe, fast and inexpensive clinical trials without the clinic.

We conduct the clinical trials through our novel remote enrollment platform, a mobile application, which allows us to run fully federal law-compliant clinical trials without ever seeing our subjects in person, without performing expensive medical tests and without dispensing expensive experimental substances. Initially we limit our testing to substances generally regarded as safe to achieve safe testing and accommodate the safety concerns of regulatory bodies. The platform can be used to develop personalized recommendations for foods, nutritional supplements and noninvasive (class I and some class II) medical devices like retainers, therapeutic eyewear and joint braces. The clinical testing can be completed with comparatively small numbers of participants—our simulation work indicates between 500 and 2000 individuals will be required to generate clinically actionable results for each intervention; customers are allowed to enroll in other trials when the trial they are in concludes.

We developed novel analytical methods that allow us to quickly process large volumes of public research data and make predictions about response to foods and supplements based on an individual's genetic data, and the clinical trials we run are designed to test those genetic signals' ability to predict response to foods and supplements. The results of these clinical trials will be new class II FDA approved medical devices (genetic tests), with a variety of monetization options.

Our unique genetic wellness service continues to be constructed with the output of the clinical trials (the genetic tests), which lead to scientifically robust personalized recommendations to consumers on how food and nutritional supplements can address longstanding chronic health concerns like migraine, airborne allergy symptoms, obesity, sleep quality and many more. These chronic health problems impact almost everyone, and multi-billion dollar industries already exist to address these needs; we will improve this situation by becoming the new way that people with these problems choose the products most likely to work for them. It is clear that we also provide an important new way that companies selling products can increase repeat customers, increase positive interactions with their products, and solve regulatory and safety concerns.

The clinical trial mobile application evaluates a user's genetic background with respect to our database of gene-environment interactions (GxEs), which are preliminary conclusions about how people with different DNA respond to their environment. It then assigns each of our users to one of the trials we are conducting to evaluate those GxEs The use is asked to change an activity (e.g., their intake of the food in question) and report their activity and response. Preferably such a clinical trial is Institutional Review Board evaluated and fully compliant with the data quality and security standards required for electronic Case Report Forms (eCRFs); the trials conducted via the mobile application can be used for product approval.

Initially, the research platform is free to users, but because we do not provide the substances we are testing we can generate revenue through product sales commissions even during the testing phase. The research platform includes a survey module that asks users one question about their health or lifestyle per day that can be used to ensure that the clinical trial platform is always testing something. Thus, data about something not previously evaluated is generated during each clinical test.

The genetic testing subscription service composes an input to the clinical trial platform. The data from the clinical trial platform helps validate our genetic tests to function as class II medical devices. Practically speaking, these tests can be bundled together under a subscription service; our subscribers will receive recommendations that have been evaluated in clinical trials for how to improve their health, and these recommendations will be continuously updated by new output from our clinical trial platform. The genetic testing service is highly scalable because of the automated nature of the analysis; adding users generates very little increase in overhead with large potential increases in revenue; there are no logistical or production costs other than computational resources, marketing and a small amount of customer service.

We have developed our preliminary correlations through data-mining of database of Genotype and Phenotype (dbGAP) datasets, but these correlations need to be tested with our research platform before they can be used in medical practice. This clinical testing will be our main activity at present, along with development of the software (mobile and web application) for the subscription service. The research platform continues to operate after launch of the service in order to improve the system and service, engender renewals of subscriptions to customers and maintain a unique service.

We are also in the process of creating an adapted version of our clinical trial application that does not evaluate genetic background, but performs clinical trials of foods, medical devices and nutritional supplements with the same remote enrollment infrastructure. While this research platform may not correlate genetic tests, it can still be used as a powerful contract research tool for the supplement industry because it will be able to conduct clinical trials at a small fraction of the cost of a traditional trial by eliminating the clinic.

### EXAMPLE 1

### The Mobile App

The inventive Mobile Application enables rapid and large-scale remote enrollment in clinical trials to evaluate gene-patient-substance interactions. It enables people to self-report signs and symptoms relating to phenotypes that are modified by various substances. The substances can be any food or beverage found on a grocery shelf or even a new drug. First, we will describe how to use the inventive Application Program Interface (API) to set up or modify interventions to be performed with the Mobile Application. The API governs the behavior of the user-side mobile application, and though it has a Graphical User Interface (GUI) to facilitate rapid and correct trial deployment it is not intended for wide use. Indeed, we are taking security measures to ensure that the API can only be accessed from the physical premises of the office. Initially, correct operation of the API and Inventive Mobile Application requires at least passing familiarity with Python, JSON, HTML and Javascript, as well as proficiency in a Linux environment for data analysis and processing; this is intended to make the platform as flexible as possible without having to patch the user-side application.

As described, this API continues in development in terms of security practice, etc., in order to ensure that the data the mobile application gathers is compliant with evolving electronic Case Report Form (eCRF) standards for an appropriate audit trail.

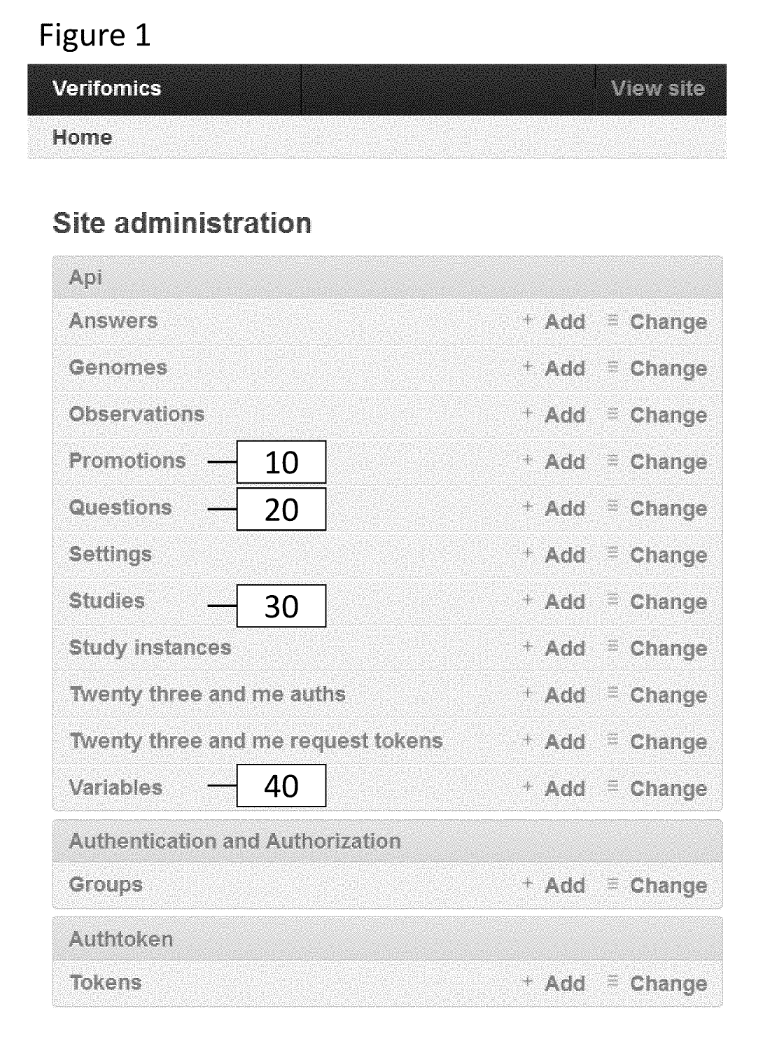

FIG. 1 is an overview of the API site administration features with several features highlighted. Promotions 10 are test substances. Questions 20 include the survey portion of the mobile API. Studies 30 indicate studies in progress. Variables 40 feature the variables that studies are designed to evaluate. These and other aspects are discussed in more detail below.

### Forms:

This section allows adding and removing forms to the system in an HTML-based format, meaning that formatting concerns can be addressed. This also allows us to link to or embed video and image content, meaning and informed consent document with an associated video verbal explanation can be generated. Forms are displayed at at least two points in the user experience—upon account creation prior to genotype upload for the main informed consent process, and then again prior to enrollment in a specific intervention. All forms use a single input format, and can be directed to either of the two form display steps by the API through this interface.

### Variables:

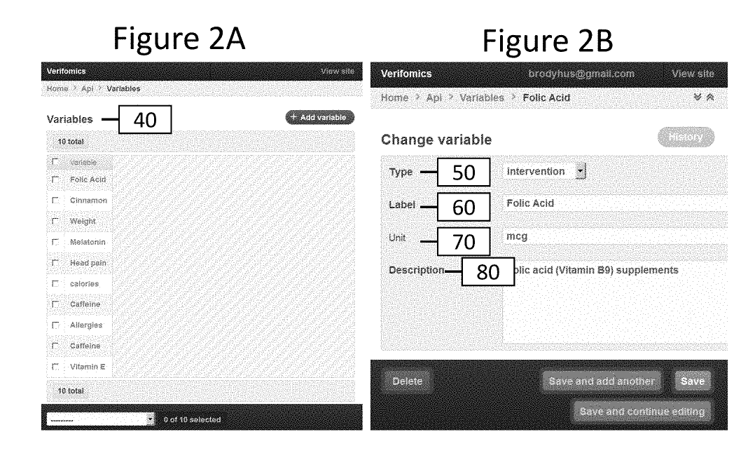

FIGS. 2A and 2B summarize handling of study variables. Study Variables 40 include at least two intervention variables, the substances to be investigated, as well as the phenotypes to be investigated. Each study utilizes at least two variables—a phenotype variable and an intervention variable. FIG. 2A displays a list of common variables which are easily selected by checking a box. FIG. 2B enables more specific creation of study variables.

The Type 50 drop-down box controls if a variable is used by the system as an intervention variable or as a phenotype variable, and will control the variable that may be used.

The Label 60 box shows the environmental variable used internally in the API as well as in a number of places in the user-side mobile API displays.

The Unit 70 box varies with the particular intervention and phenotype, as well as summary statistics and data downloads. For example, we selected the following to express exposure to the substance in question “micrograms”, “mcg”, for Folic Acid. For the weight phenotype, the units were “pounds.”

The Description 80 box permits entry of a verbal description of the phenotype or intervention to be used in a number of places in the user-side mobile API. Preferably, the description section is fully HTML compatible and accommodates rich media such as links, images and embedded videos.

### Studies:

The inventive API has been designed for ease of addition and modification of a study via the study overview section. Clicking on any of the active studies or adding a new study brings up the study modification screen, which has many features, including control over how the mobile application assigns users to studies. Because each study has a number of features to be entered before enrollment can begin, and when a study is entered into and approved on this system it becomes available for enrollment (creating a user-specific study instance from this object) when it is marked as active (active/inactive feature is in the process of implementation). “Active” indicates a study is currently accepting enrollments. This activity feature also is used to institute the attrition period described in the protocol—when a study is marked as “inactive” there is no more enrollment, but subjects already enrolled in that study continue to log data normally. Study features include, but are not limited to, the study title, phenotype, intervention, study types, user screening function, increase goal, decrease goal, short study description for increase goal and short study description for decrease goal, data logging sentence, special promotions, base promotion, and order study questions.

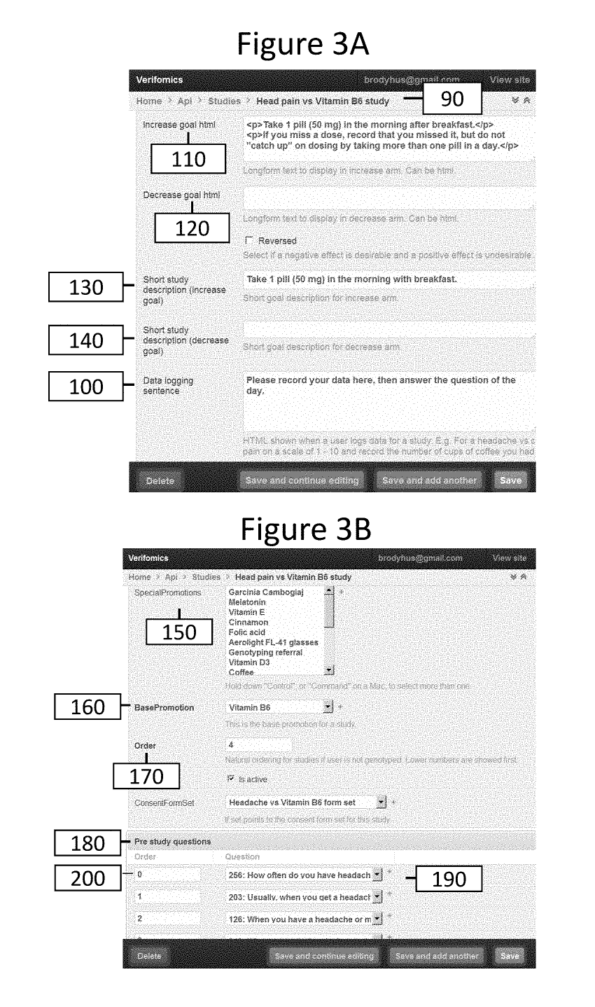

The title of the study is entered and displayed on the back-end API 90 (FIG. 3A) as well as in the dashboard/home screen of the mobile API.

The self-reported phenotype metric is recorded by subjects as part of the data logging section 100 of the mobile API. This variable is created at the variable section, though clicking the “+” next to the drop-down box to open the variable creation screen.

The intervention variable to be investigated is entered through the variable section.

The study type drop-down box allows the administrator to set an intervention as increase only, increase or decrease or decrease only. This will interact with the strength file which includes the sites considered and effect sizes for each subject in order to include or exclude subjects based on our predictions about them. For example, if a study were marked as increase-only and the predictions indicate a subject would benefit from decreasing exposure to the intervention variable, they would be excluded from the study. For example, in studies with a weight-loss medicine intervention, individuals with a normal or subnormal BMI are excluded.

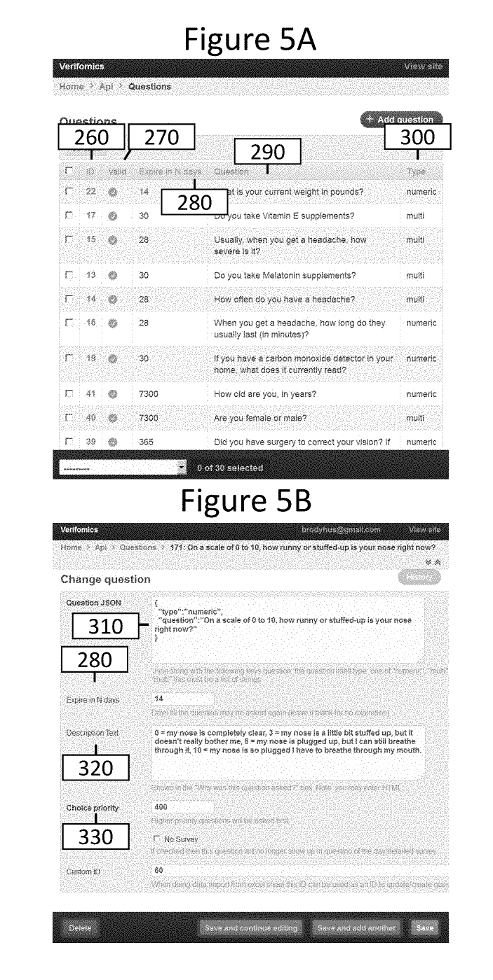

As mentioned about, the API provides User Screening. The User Screening field is designed to accept a high-level programming language which enables expressions of study inclusion and exclusion criteria in fewer lines of code, such as Python. These criteria utilize the questions and answers designed therefor. This screening function can also retrieve the results of the prediction in order to accommodate different intervention designs and to process nonlinear responses. FIG. 5A shows a set of the study questions in the study questions that are then processed as shown in the subject's answer to the first question (answers[0]). If the subject indicates he takes folic acid supplements already, he is excluded from the study.

Returning now to FIG. 3A, there is provided a box for describing “Increase Goal” 110. The text is displayed on the subject education form for subjects enrolled in the increase arm of the intervention that gives the instructions for the intervention in which they are enrolled. This information is preferably formatted via HTML, which allows links/embedded videos, images and other formatting concerns.

There is also provided a box for describing “Decrease Goal” 120. This information operates like the Increase Goal but is only shown to subjects enrolled in the decrease arm of the intervention. This Decrease Goal section can be left blank for increase-only interventions and vice versa.

Next there is a “Short Study Description (increase goal)” 130. This is the one-sentence summary of the instructions to be shown on the dashboard for subjects enrolled in the increase arm of an intervention.

Next there is a “Short Study Description (decrease goal)” 140. Here, too, the one-sentence summary operates the same as the increase goal but is shown to subjects enrolled in the decrease arm of the intervention. This box can be left blank for increase-only interventions.

Data logging 100 box is intended to provide instructions on the data logging screen for reminding to remind subjects what to record, as well as any necessary notation. It complements other subject education documents.

In FIG. 3B, there is a SpecialPromotions 150 menu to accommodate special discounts available to study participants. When a study has a substance intervention, the study must display that substance as a Base Promotion 160, but may have any number of Special Promotions 150.

BasePromotion 160 has a drop-down menu box to select the substance being tested from a menu at the Promotions section. A substance intervention requires a base promotion.

Order 170 is an additional criterion that indicates the user accounts that lack genotype information. This will not affect the behavior of the mobile application for subjects enrolled in the study.

Study Questions 180 are preliminary questions that the user-side application asks the subjects before they are enrolled or excluded from the study. These are selected from a drop-down box of all questions 190 entered into the system, and shown in the order indicated in the order column. The subjects' answer to these questions are used in the user-screening function to decide who to exclude or include in the study. These questions are identified in that function as part of the “answers” array, with an order indicated in the order column 200. For example, operating on the output of the first question asked would utilize the information stored in answers [0].

### Promotions:

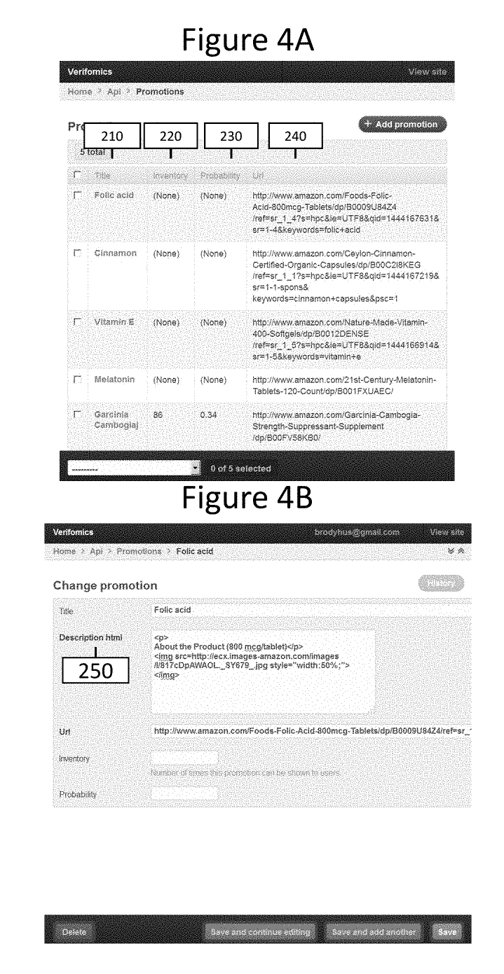

Another screen for promotions (FIG. 4A) displays a set of promotion choices. It enables the addition and modification of promotions, as well as direction of the subjects to a reputable supplier of the substance to be investigated. Each promotion has a number of features as shown below.

The promotion Title 210 is used in the user-side mobile API to label the promotion in the study.

The Inventory 220 is a cap on the quantity that can be ordered and is used when a promotion has a limited quantity. This Inventory entry ensures that the mobile API does not allocate more of that promotion than this cap. If the Inventory is left blank, the promotion is treated as though it were unlimited. For base promotions, this section should be left blank.

The unique Probability 230 box is used to describe the probability that a given subject will be allocated this promotion per day. If this box is left blank, every subject in the study assigned to this promotion will be allocated this promotion every day. This box should be left blank for base promotions.

The URL 240 links to an external provider of the substance in question; subjects can use the link at this location in the API. Preferably subjects have the option to email themselves the URL to use the information on a desktop computer as well as in the mobile API.

In FIG. 4B, the Description 250 is entered as HTML code, which describes the substance in the study. HTML code is preferred because it enables the placement of links, images, coupon codes and videos as well as a variety of formatting options. This description is also used to deliver and track discounts secured for study participants.

### Questions:

FIGS. 5A and 5B illustrate the many unique features of this inventive API. Each question in the mobile application can be modified through this interface (FIG. 5A), which also allows the addition of new questions or modification of questions the subjects do not understand FIG. 5B). This affects the behavior of the question of the day, the high-detail survey and the questions asked to determine inclusion/exclusion criteria in the study assignment process. Each question asked by the system has a number of features.

We have chosen the question coding language for its ability to handle various types of responses (multiple choice, numerical or text, “mult”, “numerical” and “text” respectively), as well as building a validator function. The provision of a high-quality code with code checking assures that the questions (created on the fly) have few issues. Initially we are providing Javascript Object Notation (JSON) code that is used to indicate the type of response and the choices possible for multiple choice questions. For use with JSON, we have built in a JSON validator function that will not accept invalid JSON prompts in order to stop imperfect JSON code, thus forestalling issues with user-side behavior.

In FIG. 5A, the ID column 260 shows a question's identification number in the database of questions. The Valid column 270 indicates whether the question has been validated or not.

The “Expire in N Days” column 280 enables the entry of time (days) before the subject will be asked this question again. Each answer given by the subject is stored separately (not overwritten) with its own Data Element Identifier. This creates longitudinal datasets with querying intervals tailored specifically to each question. For example, in FIG. 5A the question about a subject's weight is asked once every 14 days; whereas, the question about home carbon monoxide levels is asked once every 30 days. The intervals shown here can be modified in real-time in order to change the behavior of the question of the day to address specific hypotheses, safety concerns and important confounding factors, bearing in mind that each subject is only asked to answer one question per day. The Question column 290 displays the wording of the question in tabular form with the other data. And finally the Type column 300 indicates the types of answers acceptable.

In FIG. 5B, the Question JSON box 310 shows programming for the questions and possible answers. The Description Text 320 is used to explain to the subject the rationale for the question, clarify the type of answer or address other concerns. It also allows modification of the content of the explanation box shown with each question.

The Choice Priority box 330 enables giving a weight to each question that affects how often the mobile API selects a question of the day for each subject. Higher priority questions that the subject has not answered yet are more likely to be asked than lower priority questions.

### Accessing Data:

Data can be accessed for quality control and support purposes through the mobile API; however, for bulk data download and analysis a command-line interface is optimal. This is accomplished through a secure SSH system that does not use the GUI described herein. All changes, login metadata and additions to the data and back-end information governed by the API are tracked by an audit trail. The audit trail provides the date of the modification in UTC, the back-end user modifying the data, the field changed and the reason for these changes. This audit trail is stored externally from the API and may not be modified via the API.

### Other Sections:

The other sections shown in the API interface are optional and mainly provided for development purposes. These include, but are not limited to, the subject-specific study instances (an object created for each subject in the study which is populated by the information in the study section), observations (each day of data for each study instance), each subject's answer to each question, the genotype data available on each user, tokens used for interaction with the 23ANDME API and tokens used for validation of the subjects' login data. For development purposes the GUI of the API does address these topics; however, the number of subjects in the live version of the mobile application is so large that these interfaces are not practical for modification of these topics. Currently we do not intend to edit these topics from the administrator side, other than to support.

### EXAMPLE 2

### Interventional Testing of Gene-Environment Interactions (GxEs)

We have evaluated a number of large, publicly available datasets for GxEs and have established a list of candidate GxEs. To determine which GxEs are actually causal, we have developed a mobile application that allows subjects to self-report their compliance with a food, non-invasive medical device or nutritional supplement intervention and their phenotype from a select list of phenotypes that can be measured without extensive equipment or medical knowledge (Table 1). The following study investigates GxEs regarding combinations of these phenotypes and environmental factors as single phenotype:environment pairs, and generate a list of validated, causal GxEs with a high degree of power to predict subject response to a given environmental factor with respect to these phenotypes.

To this end, we enroll subjects who are already genotyped or who, to participate in the study, are willing to be genotyped. We evaluate how they are predicted to respond to the environmental factors studied with respect to the phenotypes studied, and asking them to alter their intake of one of the substances studied and report one of the phenotypes studied. Subjects are assigned to a single phenotype:environment pair at any given time. Participants trying Axon Optics therapeutic eyewear will only be investigated for headache symptoms or sleep amount/quality.

### Criteria for Subject Selection:

There are several types of criteria to consider in subject selection, including subject number, gender, age, racial and ethnic origin, inclusion criteria, exclusion criteria and vulnerable subjects.

To minimize the number of subjects, we perform simulation-based estimates for the minimal number of subjects required to generate statistically valid conclusions. Our work indicates that between 500 and 2000 individuals are required to generate viable conclusions for each intervention, leading to correct predictions in follow-up studies >90% of the time. We see no reason to establish an upper limit on subjects participating in the study because the potential benefits of the study generally far outweigh the potential risks, particularly when the substances to be investigated are foods, non-invasive medical devices such as therapeutic sunglasses or common, very low-risk dietary supplements such as Vitamin C. Further, it is possible that the signal-to-noise ratio may be substantially worse than anticipated in the simulation work, in which case larger sample sizes are needed to produce viable results than the minimum estimated.

Our interventions are not delayed until a sufficient number of subjects have agreed to the intervention because data can be gathered asynchronously. It is also optimal to begin an intervention when a subject agrees to that intervention because it is unlikely that subjects will return to the platform after a period of days or weeks to begin that intervention if they are asked to delay their participation for an undefined period of time; further, such a delay may encourage “shopping” on the platform for interventions that are currently in progress (do not have a delay).

Gender of subjects: There are no gender-based discrimination in terms of subject recruitment, with one exception. Pregnant women are excluded from the study where the substances to be investigated, such as Melatonin and Caffeine, are known to have effects on embryonic and fetal development. As indicated in Example 1, we collect gender identification to look for gender differences, which obviously requires both male and female participants.

Age of subjects: Aside from excluding minors (less than 18 years old, for whom patient consent can be complicated), there are no age restrictions for subjects. As indicated in Example 1, we collect age information to look for age-related differences.

Racial and ethnic origin: There are no intended race or ethnicity-based restrictions on enrollment in the study.

Inclusion criteria: Subjects are only enrolled in the study if they are already genotyped by a direct-to-consumer genotyping service such as 23ANDME or ANCESTRY.COM. Each phenotype:environment pair includes separate inclusion criteria which will be evaluated when a subject enters that study. These inclusion criteria include having non-optimal values of the phenotype to be investigated (e.g. overweight individuals for an intervention intending to induce weight loss; normal weight individuals would not be included). Moreover, because subjects assign themselves to a phenotype:environment pair from those under study, self-selection to a specific study is also required.

Exclusion criteria:

Exclusion criteria include, but are not limited to, pregnancy, being under 18 years old, individuals which are already taking a related substance, and any life-threatening disease such as cancer and cardiovascular disease. Other exclusion criteria include an allergy to the study substance, or if the predicted response to a substance under study is inconsistent with an improvement in health. For example, an overweight individual is excluded if he is expected to gain weight upon taking a substance in an increase-only study based on the existing GxEs.

### Vulnerable Subjects:

No vulnerable groups are considered for inclusion.

For each subject, the research includes, but is not limited to the following steps:

### Registration:

Upon downloading the Inventive mobile application, the subject is asked to create a free account using an email address. This email address does not have to be tied to their real name; it will only be stored to facilitate data retrieval and analysis. Subjects are asked to create a password for this account, preferably following standard “strong” password guidelines (longer than eight characters, at least one uppercase, one lowercase and one non-letter character).

### Informed Consent/Genotype Data Transfer:

The subject is then presented with the genotype data and survey informed consent document explaining what transfer of genotype data entails and what it will be used for. Following agreement with the informed consent document, subjects are invited to obtain their genomic profiles from sources, such as 23ANDME and ANCESTRY.COM or other genotyping service providers) to transfer their genotype data to our servers for analysis. Information on why the genotype information is required to participate in the study is shown to individuals who indicated that they were not genotyped, and they will be directed to one of the genotyping providers' ordering page if they wish to get genotyped in order to participate. Utilization of genotype data from both major direct-to-consumer genotyping services (23ANDME and ANCESTRY.COM) will be accomplished through this dual method system. Though ANCESTRY.COM genotyping is cheaper, transfer of 23ANDME genotype data is a simpler procedure for the subjects because the file transfer is between the servers and 23ANDME servers, which does not require data transfer from the subject (and so will not stress a subject's mobile data plan); as such both options will be shown to potential subjects. Subjects that get genotyped in order to participate will not be compensated for this expense.

### Initial GxE Analysis:

The subject's genotypes at the sites of interest for all phenotype:environment pairs under study are determined from this genotype information, and a prediction about their response with regard to the phenotype:environment pairs under study is calculated. Initially, this calculation is a simple additive model, but subsequent instances of a study may utilize alternative models (such as synergism, epistasis, diminishing returns or haplotype effects) to perform this calculation based on the outcome of earlier tests. An additive model is used initially because we have no a priori knowledge of the way these sites interact; however, it is biologically very plausible that interactions between these sites exist. This step is performed on the server back-end only, and the subject does not see the output of this analysis step directly.

Intervention assignment:

The subject fills out a very short survey, ten or fewer questions, in order to determine which phenotype:environment pair under study is best suited to the subject's interests and which of the GxE predictions are possible given the direction and magnitude of the subject's predicted response. For example, we exclude individuals who do not consume caffeine and who are predicted to lose weight if they drink less caffeine from the BMI:caffeine study. For the phenotype under study, the subject indicated they are most interested in modifying, the subject is presented with a list of the environmental variables under study to modify that phenotype. The subject then selects one of the environmental variables from this list they are willing to modify. A short survey that determines if the subject meets the inclusion criteria and no exclusion criteria. Then the subject is presented for each phenotype:environment pair the subject indicates interest in, and if the subject meets all inclusion criteria and does not meet any exclusion criteria, the subject is presented with the informed consent form for the specific study. If the subject is not assigned to the study, the subject is returned to the environmental variable screen, or the phenotype selection process if the subject is excluded from studies of all environmental variables under study for the original phenotype. For any type of study, there are three types of interventions possible for a given phenotype:environment pair.

### Increase-Only

Interventions only assign subjects to increase their intake of the substance under study, and subjects that are predicted to be harmed by increasing the substance in question are excluded from the study. Increase-only interventions are used in the case where a substance has a known, genotype-independent beneficial effect or a known harm associated with deficiency of the substance under study. An example of an increase-only intervention would be a bleeding gums (phenotype) vs Vitamin C (environmental factor) intervention.

### Increase or Decrease

Interventions assign subjects to either increase or decrease their intake of a substance under study depending on which of these interventions the GxE analysis indicates a possible benefit. These intervention types are used when there is no genotype-independent effect of the environmental variable on the phenotype of interest, a large fraction of the population has a significant intake of the substance in question, and when there is no potential for harm from a deficiency of the substance. An example of an increase or decrease intervention would be a BMI (phenotype) vs caffeine intake (environmental factor) intervention.

### Decrease-Only

Interventions, which would evaluate GxEs predicting response to cessation of a behavior known to be harmful (e.g. smoking, alcohol consumption) are not planned at this time.

### Informed Consent and Subject Education:

Subjects are presented with the informed consent document for the phenotype:environment pair selected, and are given detailed information on how to measure the phenotype and environmental variable under study. It is emphasized that the data is best served by honest reporting, and that there is no stigma associated with incomplete or non-compliance with the intervention, and that the subjects may stop an intervention at any time. The subject also indicate if they are willing to perform the requested change in their lifestyle; if they indicate they are unwilling or unable to perform this modification, they are returned to the earlier environmental variable selection process. The subject is also given information on where to obtain the substance under study from a reputable distributor. This step improves the scientific outcome of the study because it reduces noise in the data that may arise from differences in manufacturing practices between different providers of the substance, and it can also facilitate negotiation with manufacturers of these substances to reduce the price for subjects.

### Intervention Tracking:

The subject is then directed to the “home screen” of the inventive mobile application, which allows the subject to record their phenotype and environmental variable output on a daily basis. The inventive mobile application will generate an unobtrusive “push notification” once per day to remind the subject to record the specific behavior, though this notification can be turned off by the subject from the settings interface in the mobile application.

### Question of the Day:

The inventive mobile application will ask one question per day chosen semi-randomly (priorities and weights can be established from the server back-end to make questions more likely to appear —see above) from the list of all questions relevant to all phenotype:environment pairs under study, as well as a list of questions unrelated to ongoing work. This “question of the day” can be accessed from the inventive home screen, and answering this question is fully voluntary and does not affect the recording or analysis of behavior of the rest of the mobile application. After answering the question of the day, subjects may continue to answer questions they have not already answered within a question-specific interval between answers for as long as they wish; no question of the day will be presented to a subject if that subject has answered all questions. These questions are designed to facilitate discovery of GxEs between variables not measured in other datasets as well as provide information to be used to evaluate collinearity and confounding from other factors during the analysis step. Individual-level answers to these questions are never disclosed to outside sources, and are used only for analytical purposes by the inventors and relevant regulatory bodies.

### Data Visualization:

Subjects may view or download all data entered about them via the inventive mobile application via an integrated graphing application that allows them to spontaneously generate x/y plots for any two variables they have tracked. Subjects may also download data they have tracked in comma-delimited (.csv) format for their own purposes. Subjects may share either of these outputs with anyone of their choosing. A summary of each subject's response to and compliance with the intervention under study is displayed to each subject on the home screen for informational purposes, and subjects may view the educational and informed consent documents again at any time via the inventive mobile application during an intervention.

Study Conclusion and Reassignment:

Subjects may withdraw from an intervention they are enrolled in at any time for any reason via the inventive mobile application. Subjects doing so will be presented with a voluntary (skippable) questionnaire about their reasons for withdrawal which will be used for quality control and safety purposes. Subjects who have withdrawn from an intervention may enroll in other interventions via the same assignment procedure they went through upon registration for the Inventive platform. Because recruitment of subjects for each phenotype:environment intervention is asynchronous and depends on subject recruitment and reassignment rates, individual interventions will go through a 4-week attrition phase before their termination in which enrollment in the intervention is no longer possible. Upon conclusion of this attrition period, all subjects still in the intervention are withdrawn from the intervention by the system. This attrition period ensures that at least 4 weeks of data is collected about each subject in an intervention that does not remove themselves from it.

Quality Control and Refinement Follow-Up Interventions:

Upon conclusion of the analysis steps described below, an intervention may re-start, utilizing the refined list of GxEs determined to be causal in order to test if the predictions made by these sites are correct to the extent that the original data indicated. These interventions use the same phenotype:environment pair as the original intervention, but only base their predictions of subject response on the GxEs determined to be causal in the original intervention. Enrollment in these interventions follows the same procedure as other interventions, though they are clearly indicated as follow-up interventions.

Data Analysis and Data Monitoring:

Analysis of the causality of each GxE is conducted for all GxEs relevant to a given intervention at the same time through a method which evaluates how often a given GxE is correct in its prediction about response. This is based on the rationale that GxEs from the preliminary data that are due to a causal relationship between the environmental factor, the genotype and the phenotype make correct predictions more often than non-causal correlations which may arise from reverse causality, mediation through another variable, or statistical artifacts. Successful use of this analytical method to identify causal loci on simulated data is described below.

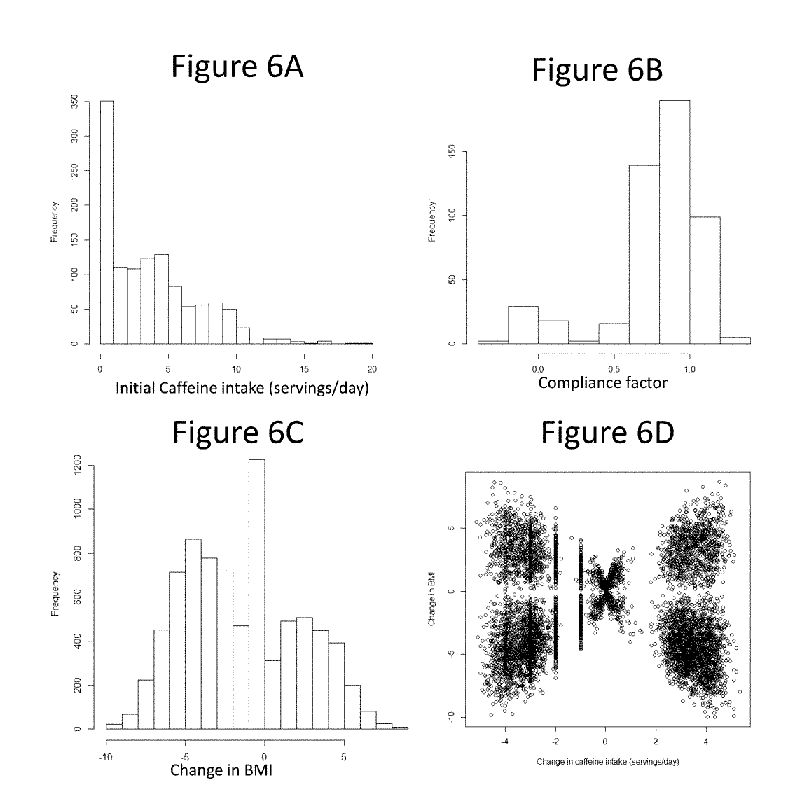

In seeking GxEs for the relationship of BMI to caffeine intake, we generated and proposed 400 GxEs, of which 30% of the GxEs were pre-assigned to be causal (in that they impact the way BMI responds to caffeine intake). The other 70% appeared to be non-causal, but were still utilized in the prediction of hypothetical subject response with similar effect sizes on caffeine response to simulate false positives in the initial GxE analysis. Eight thousand (8000) hypothetical subjects were generated with a genotype at each of the GxEs based on the allele frequency of the SNP associated with that GxE, an initial caffeine intake value from a distribution shown in FIG. 6A, an actual BMI response to caffeine that was computed from the causal loci, and a predicted BMI response to caffeine that was computed from all of the GxEs (regardless of causality).

Hypothetical subjects were then assigned to either increase or decrease caffeine intake by four servings per day based on the intervention that the predicted response indicated would cause them to lose weight, and each subject was assigned a compliance factor which was normally distributed around 1 for 90% of subjects and normally distributed around 0 for 10% of subjects FIG. 6C. Change in caffeine intake was computed by multiplying this compliance factor by the intervention assigned to each subject (4 more servings per day for increasers and 4 fewer servings per day for decreasers). Change in BMI was computed from each subject's actual response to caffeine and her change in caffeine intake FIG. 6C; for this hypothetical intervention, the prediction made by all the GxEs (of which 30% actually impacted response) were correct 67.26% of the time about the direction of response to caffeine in hypothetical subjects more than 50% compliant.

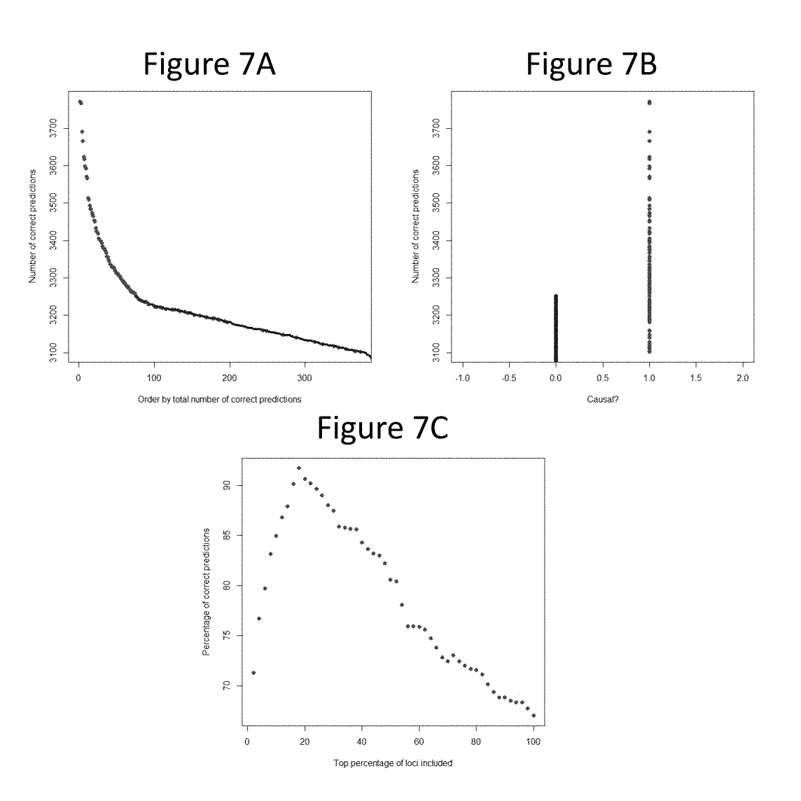

A prediction made by a GxE was scored as correct if the direction of change in BMI predicted by the GxE matched the subject's actual change in BMI. For each GxE, the total number of correct predictions made was computed among all subjects, and a clear distinction in number of correct predictions was observed between causal and non-causal loci in subjects >50% compliant FIG. 7A, with causal loci (red dots) making correct predictions about subject response much more often than non-causal loci. “Back-casting” was performed on the GxEs, which computed new predictions about subject response based on only a varying portion of the loci after ranking them by number of correct predictions in compliant subjects. The back-casting process in the analysis step used to evaluate how often the predictions would have been right if only a specific subset of the loci had been used to make predictions. We used it to identify probably causal loci during the analysis step of the intervention, with the rationale that causal loci will make correct predictions more often than non-causal loci. Based on that, back-casting is intended to arrive at a maximal rate of correct predictions when it has included the largest number of causal loci possible without including non-causal loci that may confuse the results.

After computing the new predictions, the same correct prediction evaluation was performed as in the initial analysis, and the percentage of individuals for which a correct prediction was made was computed. A distinct peak in correct prediction percentage was observed when making predictions based on the top-performing 18% of the loci, which yielded correct predictions >90% of the time, and all 72 of these loci were causal GxEs (FIG. 7C). Those GxEs present in the maximally correct fraction of loci will be considered casual for follow-up analysis, and refining studies will use the same method to drop any non-casual loci incorrectly flagged as causal by this step, and to recover causal loci incorrectly flagged as non-causal in the original analysis.

In increase-only studies, a “correct” prediction will be evaluated based on the difference between a site's predicted effect on response and each subject's actual response after normalizing for the predictions of all other GxEs evaluated. The same analytical method will be utilized as for increase or decrease studies, with the substitution of the sum of difference between actual and predicted response in place of number of correct directional predictions.

Novel GxEs will be detected from the survey data through standard statistical GxE detection methods.

### Data Monitoring and Intervention Duration:

Interventions proceed in the recruiting subjects phase for at least 4 weeks, and then in the attrition phase for another 4 weeks; however, they may be extended in order to accommodate slowly-responding phenotypes (e.g. BMI) and subject recruitment issues. Interventions are transitioned to their attrition phase when back-casting of the data as above, performed at least once every 4 weeks, yields a correct prediction percentage of greater than 90% in all subjects who have been enrolled in the intervention for at least four weeks and who are at least 50% compliant with the intervention. Further, interventions are continued until there are at least 500 subjects who are >50% compliant and who have been enrolled for at least four weeks. Interventions may also be transitioned to their attrition phase at the principal investigator's discretion, for example, if there are insurmountable recruiting issues (>6 months without 500 >50% compliant individuals) or if there is a sustained period wherein back-casts of the data do not improve (a plateau in R² for three consecutive monthly analysis time points).

Because the substances to be investigated are considered quite safe, a data monitoring committee need not be established; however, subjects who have been responding negatively (for example, gaining unwanted weight) for at least 4 weeks when analyzed at each back-casting evaluation will be administratively withdrawn from the intervention (but will still be included in the analysis). The interventions described here are anticipated to take roughly five years to be completed.

Transition from research participation: We do not plan to ask subjects to discontinue any other care they are receiving for the study conditions. Because the substances investigated are fairly benign, we anticipate no special measures required for discontinuation of an intervention.

Risk/Benefit Assessment

Risk category: Because the substances to be investigated are encountered in normal daily life, the risk to the subjects for participation is minimal.

Potential Risk:

Allergy: While the informed consent and subject education documents clearly state that subjects should not take any substances to which they have a known allergy, it is possible that subjects may have an unknown allergy to one of the substances under study. Most allergies are not life-threatening, and so by withdrawing from the study and avoiding that substance in the future, subjects may avoid further harm. Some allergic reactions can be severe and there is a low but non-zero risk of lasting morbidity and mortality from those reactions; however, because subjects are adults and the substances to be investigated are extremely common, it is very likely that severe allergies have already been detected.

Incorrect predictions: Because a fraction of the gene sites identified from the initial analysis are likely to be non-causal, predictions about subject response to an intervention may occasionally be wrong, which could lead to negative responses in terms of the phenotype under study. Though refinement and quality control interventions are expected to have a lower rate of incorrect predictions, and as the algorithms for detecting GxEs and interactions between GxEs improve, the rate of incorrect predictions can be expected to decrease.

Treatment replacement: We do not intend to replace traditional care for the phenotypes in question nor do we wish to modify subject behavior with respect to existing treatments. The informed consent and subject education documents clearly state that subjects should continue their existing therapies; however, some subjects may decide to use an inventive intervention to replace their existing treatment despite these statements.

Time and attention: As a mobile application, the inventive app utilizes a certain portion of each subject's time for data entry and answer to questions. Obviously, the subjects should perform these tasks in a safe, quite place. Some subjects may pay attention to the inventive app at inappropriate times (driving, university lectures), which could cause them physical or other harm. However, since smart phones are ubiquitous, and there are a large number of other potentially distracting mobile applications, the additional distraction and time usage risk to subjects is low.

Genetic information: While we do not evaluate a subject's ancestry, relatedness to any other individuals, or risk for disease in any context other than our selected risk factors, the services that offer direct-to-consumer genotyping do evaluate these aspects of a subject's genetic information. For logistical purposes subjects are required to be genotyped prior to their participation. As such, there is a risk that a subject who is genotyped prior to study participation may learn something about ancestry or disease risk he or she would rather not have learned.

Financial: The inventive mobile application uses the subjects' existing data plans to send and receive data. We have taken every measure to reduce the study data size required to send or receive from the subjects. We do not compensate subjects for obtaining the substances in the interventions, nor for the cost of genotyping, both of which constitute financial risk to the subjects.

Protection Against Risks:

Allergy: Informed consent and subject education documents clearly warn subjects not to use substances to which they are allergic. The informed consent document also indicates that subjects should immediately withdraw from any intervention they feel is harming them. The monthly preliminary data analysis may also detect subjects who are allergic to a substance depending on the data available about them, and if that is detected they are warned to stop all participation.

Incorrect predictions: The monthly evaluation of the correct prediction rate and negatively responding subjects is designed to allow studies to enter their attrition phase and end when enough data has been gathered to substantially improve our predictions of subject response to an environmental factor. As such, the maximum amount of time that a given subject may be part of an intervention and responding in a negative way is just under two months before being withdrawn from the intervention. However, subjects daily receive information about their response to an intervention, so it is likely that subjects will withdraw from an intervention harming them well before an administrative cutoff. Because an intervention ends when it has improved the correct prediction rate, subsequent refinement and quality control interventions are likely to have higher rates of correct predictions.

Treatment replacement: If subjects have replaced their existing treatment with a new substance, it is likely that they will appear to respond negatively to the intervention and as such be dropped from the intervention in the same manner as an incorrect prediction. While this will add noise to the data, the same mechanism to reduce subject risk applies to treatment replacement as applies to incorrect predictions.

Time and attention: The mobile application interface has been designed for daily completion in less than two minutes, thus minimizing the attention required.

Genetic information: The analyses provided by the direct-to-consumer genotyping services are now “opt-in”, and they have their own informed consent procedures, so the risk of learning information the subject would have preferred not to learn is low.

Financial: We will make every effort to reduce the subject participation cost, for instance, by negotiating with manufacturers for discounts on the substance in question for subjects. However, because of the scale of the interventions, compensating subjects for these substances or for the genotyping required to participate is not possible. The subjects most likely to enroll in the study are those subjects who are already genotyped, because our service is a free add-on to a product already paid for. Therefore, it is expected that the majority of subjects will already be genotyped, rather than getting genotyped in order to participate. Further, because of advancements in imputation and greater knowledge about recombination rates and rare variants, genotype information is unlikely to become obsolete, and advances in our understanding of the genome are only going to make our testing more useful to subjects in the future.

Potential Benefits to the Subjects

Correct predictions: Some predictions made about subject response to an environmental factor will be correct in these interventions, and the subjects who are compliant with a correct prediction will benefit in terms of the phenotype under study improving. As initial interventions conclude and refinement and quality control interventions start, the proportion of correct predictions should increase.

Entertainment: Because very few actionable recommendations can be made from genetic data at the present time, it is likely that the majority of individuals who are already genotyped did so because they are interested in biology and genetics. We present feedback to subjects about their genetic information and allow them to participate in an activity that is relevant to this interest, and as such there is substantial entertainment value in participation. Further, this benefit is accentuated for the subjects through a surprising question of the day, real-time feedback on their responses to an intervention, the integrated graphing application and the ability to download and share their data in .csv format.

Mindfulness: A large part of standard-of-care interventions for a number of phenotypes under study, such as obesity, involve increased attention to diet and lifestyle. By requiring subjects to log data daily during an intervention, participation in the study may increase mindfulness and thereby augment standard-of-care interventions for these phenotypes.

Financial: A number of corporate wellness programs and health insurance companies provide financial incentives to improve risk factors for diseases, such as obesity. When our inventive intervention facilitates improvements in one of these risk factors, the subject may obtain a financial benefit. Further, improvement in a study phenotype may reduce the need for existing therapies (e.g., less over-the-counter pain medication if migraine frequency is reduced), which also can benefit subjects financially.

Genetic background-specific results: Because the output of these interventions will be used to develop new genetic tests for actionable recommendations, participating in the inventive studies ensures that these tests will be calibrated to an individual's genetic and ethnic background. If the results are less applicable to another group, participation by individuals in that group will allow the analysis to accommodate that difference.

Alternatives to participation: The majority of the initial studies of phenotypes have existing therapies; thus, subjects are free to pursue these therapies even during an intervention.

Subject Identification, Recruitment and Consent/Assent

Method of subject identification and recruitment: Subjects will be identified and enrolled through an informational website about our new studies, and through information about the inventive app available through the Android and iOS app stores. The informational website and the concept and aims of our invention will be provided to the media through a number of avenues (technology interest groups, the Quantified Self hobby group, the lay media, and motivated patient communities via special-interest blogs). Initially there will be no financial inducement or other possible undue influence for subjects to participate, and none of the promotion will make medical claims. We intend to publish a subset of its results and analysis of all of the untested GxE correlations in open-access peer-reviewed academic journals, which also will include references to the informational website.

Process of consent: The mobile application provides a process for obtaining informed consent from participants electronically. It shows subjects a tutorial screen to explain why informed consent is needed, and then the informed consent forms are presented and followed by a series of checkboxes that re-assert the main points of the informed consent document. The informed consent process is complete when subjects have checked all the boxes affirming their understanding. In addition, subjects have the opportunity to ask questions about the protocol via email, as well as take as much time to review and discuss the documents as they require. Subjects also are directed to the FAQ page, which is updated with answers to questions received about the protocol (without subject identification).

To indicate their consent and sign the documents, subjects enter their full names to function as their signature, as well as enter initials below this electronic signature. The date they sign is populated automatically when the forms are submitted. The server then checks that the forms have been completed, emails a copy of the completed forms to the subjects for their records, and stores the forms.

The subject is next presented with the informed consent document to enable transfer of genotype data prior to that transfer. Our informed consent informs them why we need that data. Subjects are presented with a study-specific informed consent document prior to their enrollment in a study, explaining the risks and benefits of that study. The same consent process occurs for the intervention-specific consents.

Intervention consents are created from a general template form, as well as from the phenotype-specific and environmental factor-specific consent templates. For example, to create an intervention-specific consent for niacin supplementation with respect to BMI, the general template, weight-specific template and niacin-specific templates are combined to yield the consent document for that intervention.

Subject capacity: No subjects with reduced mental capacity to give informed consent are intended to be recruited.

Subject/representative comprehension: Comprehension of the informed consent process is assessed by the subject's indication of understanding the documents as indicated by the checked boxes during the informed consent process. It is notable that in order to be enrolled in an intervention via the mobile application, a subject must have the literacy and capability to remember two passwords, upload genotype data from a third party provider, navigate a number of menu screens and answer several questions in an intelligible way, which will require a certain degree of comprehension.

Debriefing procedures: Information is not purposefully withheld from the subjects.

Documentation of consent: Documentation of consent is stored temporarily on the mobile application server and then transferred to encrypted hard drives in a locked facility at every backup.

Costs to the subject: Initially subjects incur costs of participation in only obtaining the substances under study. Of course, if they have not previously obtained their genotype, the genotyping service is an additional to participate in the study. For an individual subject, the costs of the substances under study will be low, but the scale variety of planned interventions currently prohibits providing the substances free to all subjects. Subjects have an opportunity to directly benefit from the intervention, and efforts to reduce the costs of participation are underway (including but not limited to negotiating discounts with substance manufacturers). Initially, subjects genotyped in order to participate are not reimbursed for the costs of genotyping; however, as mentioned above, there are benefits associated with participation in the inventive platform. No substances under study are investigational drugs. We do not presently sell any of the substances nor genotyping services.

Payment for Participation:

Subjects are not reimbursed for their participation.

Glossary of Terms:

Phenotype:

A specific, measurable aspect of a subject's health, or the output of a biological process.

Environmental Factor:

Some aspect of a subject's lifestyle or environment, such as their green vegetable intake or their average daily carbon monoxide exposure.

Phenotype:Environment Pair:

The specific pair of measureable biological property (phenotype) and environment/lifestyle factor that a given intervention addresses. For example, bleeding gums (phenotype) vs. Vitamin C (environmental factor) would be a phenotype:environment pair. The intervention would study how much individuals with different genotypes improve in terms of their bleeding gums (reduction in frequency or amount of bleeding) as they increase vitamin C intake, to identify individuals for whom recommending an increase in Vitamin C intake will help.

Gene-Environment Interaction (GxE): The interaction between an individual's genetic background and some aspect of their lifestyle to produce a specific result. Here, we evaluate GxEs such that each GxE makes a prediction about a specific aspect of an individual's health (a phenotype) based on their genotype and a specific aspect of an individual's lifestyle (an environmental factor).

Causal relationship: In this case, a relationship between a genetic polymorphism, such as a T in a specific place in the DNA, and a deterministic response in the organism. For example, if individuals with a T at a specific place in the DNA always gain weight when exposed to caffeine because of their genetic code, that would be a causal relationship.

Reverse causal relationship: In this case, a relationship between a genetic polymorphism and an output that gives the misleading impression of causality, but does not alter the response to the environmental factor. For example, if people with a T in their DNA at a specific place are always obese when they have high caffeine intake, that could be that they are obese because they have high caffeine intake (causal relationship), or it could be that they have high caffeine intake because they are obese (reverse causal relationship). Reverse causality can appear as a signal in GxE discovery studies, but it does not have predictive power and can lead to incorrect predictions if predictions are made without determining causality.

Statistical artifact: An erroneous detection, in this case of a GxE, due to the inevitable imperfections of genome-scale statistical analysis. Statistical artifacts can also lead to incorrect predictions, and they also do not have predictive power.

Intervention: An activity of the Inventive Mobile Application wherein subjects are asked to change one aspect of their lifestyle and log one or more phenotypes. Each intervention has an underlying phenotype:environment pair.

Genotype/Genotyping: The sequence of a subject at a subset of positions in the DNA. Genotyping is offered as a direct-to-consumer service through a number of providers, such as 23andMe and Ancestry.com. Genotyping is distinct from sequencing, but it is most useful for these analyses because it is cheaper and the sites measured during genotyping are the sites at which people are most likely to differ.

Additive model: A predictive model assuming that each individual position in the genome that has a candidate GxE operates independently from all other positions. In an additive model, a prediction is made about a subject by adding up the effect size at all candidate GxEs.

Synergism: A model that would assume certain candidate GxEs operate more strongly when they are in combination. For example, a synergistic model may assume that two GxEs based on two proteins that are the only two ways to accomplish the same result would amplify one another's effects. A number of statistical techniques are possible to evaluate synergism and epistasis, however until data about which sites are causal is available they cannot be optimized.

Epistasis: A model that would assume the prediction of some candidate GxEs would supersede or “cancel out” the effect of other candidate GxEs. For example, if one GxE was within a gene that was “upstream”, or regulating a gene that had another GxE, the effect of the upstream GxE may occur no matter what the downstream GxE dictates. An analogous process would be to say that a circuit breaker is epistatic to a light switch, because if the circuit breaker is off, it doesn't matter if the light switch is on.

Diminishing returns: A model that would assume that having multiple GxEs making the same prediction produces a response in the subject in something other than a fully additive way, such as by saturating the system and producing a “plateau-like” response. This is almost certainly more true than an additive model, however not enough is known about the causal sites and the way they interact to produce a model with high statistical veracity, and it is likely that the characteristics of the diminishing returns function varies by substance and phenotype.

Haplotype effects: Effects on some biological process that depend not only on a subject's genotype at a specific place in their genome, but the combination of their genotypes at a number of interacting sites. While a number of these phenomena are known to occur, the number of possibilities for them is virtually limitless, which makes multiple testing correction very challenging. Haplotype effects will be investigated in the analysis steps after causal loci have been identified.

The behavior of the mobile application is centrally controlled by the back-end server, so interventions may be modified without patching the user-side application. Inclusion and exclusion of subjects from an intervention is accomplished by evaluation of their answers to a number of screening questions, and this screening function can be edited directly. In the example below, the mobile application asks subjects who are interested in this intervention on how melatonin effects head pain four questions, and then after the fourth question evaluates if they are a good candidate for the study. In this example, there are two exclusion criteria; subjects that do not get headaches often enough for the intervention to realistically generate usable data (less than one headache per week), and subjects that already take melatonin supplements are excluded. Subjects excluded from this intervention are presented with a message about why they were excluded, and allowed to go through the same process for other interventions they are interested in; subjects cannot attempt to re-enroll in a study after being excluded, preventing them from changing their answers in order to be enrolled. Subjects enrolled in the intervention will be presented with the subject education documentation, and then proceed to the dashboard/home screen. Each intervention may be set up with any number of questions defining inclusion or exclusion of subjects prior to enrollment, and can utilize any logic possible in Python (a Turing-complete programming language) to enroll or exclude subjects based on their answers. This logic can also operate on the output of the GxE analysis, in order to accommodate increase or decrease intervention designs and exclude individuals who are predicted to be harmed by the substance.

### EXAMPLE 3

### Clinical Trial of Special Spectacles

Preliminary correlations about Axon Optics glasses were generated from the data sets of the Multi-Ethnic Study of Atherosclerosis (MESA) and National Eye Institute (NEI) Age Related Eye Disease Study (AREDS). The Axon lenses were developed as part of research at the University of Utah by Dr. Bradley Katz, a neuro-ophthalmologist who works with light-sensitive migraine patients. Axon glasses have been tested in a clinical setting before (PMID: 16815254), and they work through reduction in exposure to light in the near-UV range for individuals with underlying photophobia or light sensitivity. We used this mechanism (light exposure reduction) to generate preliminary predictions about individual response to the glasses, with the rationale that individuals predicted to be harmed by sunlight or bright indoor lighting like TVs are predicted to benefit from the glasses via reduction of these stimuli.

Correlations between genotype, headache symptoms and sunlight exposure were generated by using the AREDS dataset, which measured average daily sunlight exposure from April through September and reported headaches as an adverse event during the study. Correlations between genotype, sleep amount and quality and light exposure were generated using the MESA study, which measured sleep amount and quality as well as a variety of variables that indirectly address sunlight and fluorescent light exposure. Measurements in the MESA study of hours of yard work, walking, outdoor exercise and hours spent watching TV were used to compile a bright or fluorescent light index, which was used to generate preliminary correlations between sleep amount and quality and photophobia/light-induced circadian issues.

Other variations on the above methods include but are not limited to, animal studies. For example, pet owners could report the breed (phenotype) of the dog or cat. The pet owner then reports use of the intervention (experimental substance) and pet symptoms.

Various steps can be deleted for the use of coexisting technology. For example, the patient need not register if such information comes from a different source, such as a Google account or another associated provider such as a genotype profiling company. Alternately, the user need not download genotype data if provided by another route. Even without the questionnaire, the trials can still be performed. Alternately, participating patients can choose among the various trials.

The same patient powered, remote entry platform is useful for non-genotype clinical tests. Examples of other kinds of biological information include but are not limited to metabolic tests, RNA expression, methylation and sequencing information. In addition, other patient information to be collected include but are not limited to the use of images and gender as test variables. It is already known that different genders process alcohol differently, and there are probably other, as yet undocumented differences.

Although specific embodiments have been illustrated and described herein, those of ordinary skill in the art will appreciate that any arrangement calculated to achieve same purposes can be substituted for the specific embodiments shown. This disclosure is intended to cover any and all adaptations or variations of various embodiments of the invention, it is to be understood that the above description has been made in an illustrative fashion, and not a restrictive one. Combinations of the above embodiments, and other embodiments not specifically described herein will be apparent to those of skill in die art upon reviewing the above description. The scope of various embodiments of the invention includes nay other applications in which the above structures and methods are used. Therefore, the scope of various embodiments of the invention should be determined with reference to the appended claims, along with the full range of equivalents to which such claims are entitled.

In the foregoing description, if various features are grouped together in a single embodiment for the purpose of streamlining the disclosure, this method of disclosure is not to be interpreted as reflecting an intention that the claimed embodiments of the invention require more features than are expressly recited in each claim. Rather, as the following claims reflect, inventive subject matter lies in less than all features of a single disclosed embodiment. Thus the following claims, and such other claims as may later be added, are hereby incorporated into the description of the embodiments of the invention, with each claim standing on its own as a separate preferred embodiment.

Reference throughout this specification to an “embodiment,” an “example” or similar language means that a particular feature, structure, characteristic, or combinations thereof described in connection with the embodiment is included in at least one embodiment of the present invention. Thus appearances of the phrases an “embodiment,” and “example,” and similar language throughout this specification may, but do not necessarily, all refer to the same embodiment, to different embodiments, or to one or more of the figures. Additional, reference to the words “embodiment”, “example” or the like for two or more features, elements, etc., does not mean that the features are necessarily related, dissimilar, the same, etc.

Each statement of an embodiment or example is to be considered independent of any other statement of an embodiment despite any use of similar or identical language characterizing each embodiment. Therefore, where on embodiment is identified as “another embodiment,” the identified embodiment is independent of any other embodiments characterized by the language “another embodiment.” The features, functions and the like described herein are considered to be able to be combined in whole or in part one with another as the claims and/or art may direct, either directly or indirectly, implicitly or explicitly.

As used herein, “comprising,” “including,” “containing,” “is,” “are,” “characterized by,” and grammatical equivalents thereof are inclusive or open-ended terms that do not exclude additional un-recited elements or method steps. “Comprising” is to be interpreted broadly and including the more restrictive terms “consisting of” and “consisting essentially of.”

Reference throughout this specification to features, advantages, or similar language does not imply that all of features and advantages that may be realized with the present invention should be or are in any single embodiment of the invention. Rather, language referring to the features and advantages is understood to mean that a specific feature, advantage or characteristic described in connection with an embodiment is included in at least one embodiment of the present invention. Thus, discussion of the features and advantages, and similar language, throughout this specification may, but does not necessarily, refer to the same embodiment.

Furthermore, the described features, advantages,and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

Now that the invention has been described, what follows is a discussion of some uses and implementations of the invention.

A first embodiment of the invention comprises a method of conducting a clinical trial by automated means, the method including one or a plurality of:
1. providing a telephone or other electronic device for data entry and viewing;
2. providing a server programmed to provide one or a plurality of processing, storage, validation, GUI interfaces, accounts management or other back-end or front-end services;
3. performing user authentication through an authentication means comprising one or a plurality of: accessing a login screen for entering user identification and password; biometric validation by means of fingerprint, retinal scan or other biometric information; use of an authentication device or service;
4. displaying information about one or a plurality of clinical trials for the user to decide whether to participate in one or a plurality of clinical trials;
5. displaying further pages about one or a plurality of clinical trials with data entry boxes or other means enabling the user to consent by typing in name, initials and/or checking boxes;
6. enabling user to upload an existing genotype profile or to authorize the use of a genotype profile stored elsewhere, for inclusion in the clinical trial;
7. providing a questionnaire, whose answers relate to the presence or absence of any of one or a plurality of phenotypes in one or a plurality of clinical trials;
8. comparing the genotype profile and questionnaire answers with a one or a plurality of clinical trials, each having a required phenotype and an intervention;
9. identifying one or a plurality of qualifying choices of clinical trial;
10. providing the user with information on the qualifying choice or choices of study phenotype and intervention and asking user if user agrees to make the intervention;
11. if user agrees to accept a choice of clinical study, assigning user to the clinical study;
12. enabling user data entry of one or a plurality of data variables relating to the study, such data entry performed by one or a plurality of: typing, tracing, dictation, biometric measurement, photography, videography;
13. storing the data variables entered by the user on a server

Some embodiments of the invention comprise an online clinical trial enrollment system which is comprised of one or a plurality of the following:
1. a patient-operated device for reading displayed commands and inputting responses;
2. a server programmed to archive and process data from a plurality of patients
3. a new user registration means
4. an informed consent with information on the clinical trial and means for user consent;
5. a qualifying questionnaire;
6. a genotype entry means comprising one or a plurality of: genotype upload capability, genotype transfer from an external server capability, genotype transfer authorization capability;
7. a display of one or a plurality of clinical trial choices
8. a user query for acceptance of clinical trial choice
9. one or a plurality of screens with specific information and questions relating to the clinical trial.

Some embodiments of the above online clinical trial enrollment system further comprise the steps of selecting one or a plurality of clinical trials based on a comparison of the user's genotype profile and questionnaire answers with the study phenotype and intervention such that the clinical trial or trials initially displayed to the user are those most likely to result in a beneficial effect for the user.

Some embodiments of the online clinical trial enrollment system further comprise the steps of referring user to sales/referral screen after user has agreed to participate in a particular clinical trial, to inform user of details on the activity to be performed or substance to be accessed and used. Some embodiments further comprise the step of enabling the user to purchase one or a plurality of substances to be used in the clinical trial, by either incorporating purchase means or by linking to another application or web site which incorporates purchase means

An embodiment of the invention is a system for conducting clinical trials, the system comprising:
1. a patient-operated device for reading displayed commands and inputting responses;
2. a server programmed to archive and process data from a plurality of patients.
3. a new user registration means;
4. an informed consent with information on the clinical trial and pages for user consent;
5. a qualifying questionnaire;
6. a genotype upload and transfer means;
7. a display of optimal clinical trial choice with user compliance question;
8. screens with specific information;
9. a screen with selections for a more detailed questionnaire, account details and data input;
10. one or a plurality of data input screens on which the user inputs performance with regard to the specific clinical trial;
11. at least one screen showing user data;
12. programming for analyzing and aggregating multi-user data for a clinical trial;
13. reports of analyzed and aggregated clinical trial data

1. A method of conducting a clinical trial by automated means, the method comprising the following steps:
a. providing a telephone or other electronic device for data entry and viewing;
b. providing a server programmed to provide one or a plurality of processing, storage, validation, GUI interfaces, accounts management or other back-end or front-end services;
c. performing user authentication through an authentication means comprising one or a plurality of: accessing a login screen for entering user identification and password; biometric validation by means of fingerprint, retinal scan or other biometric information; use of an authentication device or service;
d. displaying information about one or a plurality of clinical trials for the user to decide whether to participate in one or a plurality of clinical trials;
e. displaying further pages about one or a plurality of clinical trials with data entry boxes or other means enabling the user to consent by typing in name, initials and/or checking boxes;
f. enabling user to upload an existing genotype profile or to authorize the use of a genotype profile stored elsewhere, for inclusion in the clinical trial;
g. providing a questionnaire, whose answers relate to the presence or absence of any of one or a plurality of phenotypes in one or a plurality of clinical trials;
h. comparing the genotype profile and questionnaire answers with a one or a plurality of clinical trials, each having a required phenotype and an intervention;
i. identifying one or a plurality of qualifying choices of clinical trial;
j. providing the user with information on the qualifying choice or choices of study phenotype and intervention and asking user if user agrees to make the intervention;
k. if user agrees to accept a choice of clinical study, assigning user to the clinical study;
l. enabling user data entry of one or a plurality of data variables relating to the study, such data entry performed by one or a plurality of: typing, tracing, dictation, biometric measurement, photography, videography;
m. storing the data variables entered by the user on a server

2. An online clinical trial enrollment system comprising:
a. a patient-operated device for reading displayed commands and inputting responses;
b. a server programmed to archive and process data from a plurality of patients
c. a new user registration means
d. an informed consent with information on the clinical trial and means for user consent;
e. a qualifying questionnaire;
f. a genotype entry means comprising one or a plurality of: genotype upload capability, genotype transfer from an external server capability, genotype transfer authorization capability;
g. a display of one or a plurality of clinical trial choices
h. a user query for acceptance of clinical trial choice
i. one or a plurality of screens with specific information and questions relating to the clinical trial.

3. The online clinical trial enrollment system of claim 2 further comprising the steps of selecting one or a plurality of clinical trials based on a comparison of the user' s genotype profile and questionnaire answers with the study phenotype and intervention such that the clinical trial or trials initially displayed to the user are those most likely to result in a beneficial effect for the user.

4. The online clinical trial enrollment system of claim 2 further comprising the steps of referring user to sales/referral screen after user has agreed to participate in a particular clinical trial, to inform user of details on the activity to be performed or substance to be accessed and used.

5. The online clinical trial enrollment system of claim 2 further comprising the step of enabling the user to purchase one or a plurality of substances to be used in the clinical trial, by either incorporating purchase means or by linking to another application or web site which incorporates purchase means.

6. A system for conducting clinical trials, the system comprising
a. a patient-operated device for reading displayed commands and inputting responses;
b. a server programmed to archive and process data from a plurality of patients.
c. a new user registration means;
d. an informed consent with information on the clinical trial and pages for user consent;
e. a qualifying questionnaire;
f. a genotype upload and transfer means;
g. a display of optimal clinical trial choice with user compliance question;
h. screens with specific information;
i. a screen with selections for a more detailed questionnaire, account details and data input;
j. one or a plurality of data input screens on which the user inputs performance with regard to the specific clinical trial;
k. at least one screen showing user data;
l. programming for analyzing and aggregating multi-user data for a clinical trial;
m. reports of analyzed and aggregated clinical trial data
